(19) United States
(12) Patent Application Publication
(10) Pub. No.: US 2023/0164704 A1
(43) Pub. Date: May 25, 2023

(54) GROUP COMMON DOWNLINK CONTROL INFORMATION FOR TRANSMISSION POWER CONTROL IN MULTI-PANEL UPLINK TRANSMISSION

(71) Applicant: QUALCOMM Incorporated, San Diego, CA (US)

(72) Inventors: Fang YUAN, Beijing (CN); Wooseok NAM, San Diego, CA (US); Mostafa KHOSHNEVISAN, San Diego, CA (US); Tao LUO, San Diego, CA (US)

(21) Appl. No.: 17/920,309

(22) PCT Filed: Apr. 28, 2020
(86) PCT No.: PCT/CN2020/087480

§ 371 Date: Oct. 20, 2022

(51) Int. Cl. H04W 52/34; H04W 52/14

(52) U.S. Cl. CPC H04W 52/346; H04W 52/143

(57) ABSTRACT

Aspects of the disclosure relate to wireless communication systems that support multi-panel uplink transmissions. Transmission power control (TPC) commands are conveyed in a group common downlink control information (DCI) to support the multi-panel uplink transmissions. Additionally, the DCI can explicitly indicate which uplink panel TPC commands are associated with a particular panel through an explicit panel identification in the DCI, radio resource control (RRC) configuring TPC blocks in a DCI for a particular cell, or by two DCIs in respective search spaces where the TPC in each respective DCI are associated with a corresponding uplink panel transmission.

### TECHNICAL FIELD

The technology discussed herein relates generally to wireless communication systems and, more particularly, to group common downlink control information (DCI) for transmission power control (TPC) in multi-panel uplink transmissions.

### INTRODUCTION

In certain wireless communication systems such as 3GPPs 5G new radio (5G NR), various mechanisms are used for control of the power for uplink (UL) transmissions from a device such as user equipment (UE) to a base station or gNodeB (gNB). Transmit power control (TPC) commands or information are typically sent from a gNB to a UE over downlink channels to provide power control information used by the UE to control the power on the uplink channels. The TPC information is sent by a gNB in a group common DCI that is configured for single panel uplink transmissions by UE. In multiple input and multiple output (MIMO) wireless systems, however, devices such as UEs may employ multiple panel transmission schemes (e.g., multi-panel transmissions from multiple antenna panels) including spatial multiplexing, joint transmission, and time diversity. For such multi-panel transmission schemes, development of conveying TPC commands in a group common DCI would be beneficial.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method of wireless communication in a wireless communication network at a scheduling entity is disclosed. The method includes determining transport power control (TPC) information for multi-panel uplink transmissions, the TPC information configured to provide an indication for TPC pertaining to each panel transmission in the multi-panel uplink transmissions. Additionally, the method includes configuring a group common downlink control information (DCI) that is common to a group of user equipment (UE) to include the TPC information, and transmitting the group common DCI to at least one UE in the group of UEs.

According to another aspect, a wireless communication device is disclosed that includes a processor, a wireless transceiver communicatively coupled to the processor; and a memory communicatively coupled to the processor. The processor and the memory are configured to determine, within a scheduling entity, transport power control (TPC) information for multi-panel uplink transmissions, the TPC information configured to provide an indication for TPC pertaining to each panel transmission in the multi-panel uplink transmissions. Further, the processor and the memory are configured to configure a group common downlink control information (DCI) that is common to a group of user equipment (UE) to include the TPC information, and transmit the group common DCI to at least one UE in the group of UEs.

According to further aspects, a wireless communication device in a wireless communication network is disclosed that includes means for determining, in a scheduled entity, transport power control (TPC) information for multi-panel uplink transmissions, the TPC information configured to provide an indication for TPC pertaining to each panel transmission in the multi-panel uplink transmission. The device further includes means for configuring a group common downlink control information (DCI) that is common to a group of user equipment (UE) to include the TPC information, and means for transmitting the group common DCI to at least one UE in the group of UEs.

In yet other aspects, an article of manufacture for use by a wireless communication device in a wireless communication network is disclosed. The article includes a computer-readable medium having stored therein instructions executable by one or more processors of the wireless communication device to determine, within a scheduling entity, transport power control (TPC) information for multi-panel uplink transmissions, the TPC information configured to provide an indication for TPC pertaining to each panel transmission in the multi-panel uplink transmissions. The article also includes instructions executable by the one or more processors of the wireless communication device to configure a group common downlink control information (DCI) that is common to a group of user equipment (UE) to include the TPC information, and transmit the group common DCI to at least one UE in the group of UEs.

In another example, a method of wireless communication in a wireless communication network at a scheduled entity is disclosed. The method includes receiving, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions. Additionally, the method includes determining the TPC setting for each panel uplink transmission based on the received group common DCI.

According to another aspect, a wireless communication device is disclosed that includes a processor, a wireless transceiver communicatively coupled to the processor; and a memory communicatively coupled to the processor. The processor and the memory are configured to receive, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions. Additionally, the processor and the memory are configured to determine the TPC setting for each panel uplink transmission based on the received group common DCI.

In yet another example, a wireless communication device in a wireless communication network is disclosed that includes means for receiving, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions. The device also includes means for determining the TPC setting for each panel uplink transmission based on the received group common DCI.

In yet other aspects, an article of manufacture for use by a wireless communication device in a wireless communication network is disclosed. The article includes a computer-readable medium having stored therein instructions executable by one or more processors of the wireless communication device to receive, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions. The instructions also include instructions to determine the TPC setting for each panel uplink transmission based on the received group common DCI.

These and other aspects will become more fully understood upon a review of the detailed description, which follows. Other aspects, features, and embodiments will become apparent to those of ordinary skill in the art, upon reviewing the following description of specific, exemplary embodiments of in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an organization of wireless resources in an air interface utilizing orthogonal frequency divisional multiplexing (OFDM) according to some aspects.

FIG. 4 illustrates an example of blocks of downlink control information (DCI) according to some aspects

FIG. 5A illustrates an exemplary RRC configuration for a PUCCH transmit power control command.

FIG. 5B illustrates an exemplary RRC configuration for a PUSCH transmit power control command.

FIG. 6 illustrates exemplary plots of multi-panel transmissions over time for various multiplexing schemes according to some aspects.

FIG. 7A illustrates an exemplary configuration of a group common DCI that provides an indication of a panel identifier within the DCI according to some aspects.

FIG. 7B illustrates another exemplary configuration of a group common DCI having an arrangement of fields that indicates a TPC configuration according to some aspects.

FIG. 8 illustrates an exemplary RRC configuration for providing a per panel indication of TPC according to some aspects.

FIG. 9 illustrates a time/frequency plot of another example using multiple DCIs for scheduling a multi-panel uplink transmission according to some aspects.

FIG. 10 illustrates an example of the structure of the DCIs used in the example of FIG. 9.

FIG. 11 is a flow diagram of an exemplary method for providing group common downlink control information for transmission power control in a multi-panel uplink transmission according to some aspects.

FIG. 12 is a flow diagram of an exemplary method for receiving and utilizing group common downlink control information for transmission power control in a multi-panel uplink transmission according to some aspects.

FIG. 13 is a block diagram illustrating an example of a hardware implementation for a base station, gNB, or scheduling entity employing a processing system according to some aspects.

FIG. 14 is a block diagram illustrating an example of a hardware implementation for a UE or scheduled entity employing a processing system according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In certain wireless communication systems, only single panel uplink transmissions are supported and a group common DCI for transmit power control (TPC) is designed for only single panel uplink transmissions. In other wireless communication systems, however, multi-panel uplink transmissions may be supported. Accordingly, the present disclosure provides for conveying TPC commands in a group common DCI to support multi-panel uplink transmissions. In an aspect, the present disclosure provides various designs for the group common DCI including TPC indications for multi-panel uplink transmissions or single panel (e.g., TPC indications per-panel) uplink transmissions.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

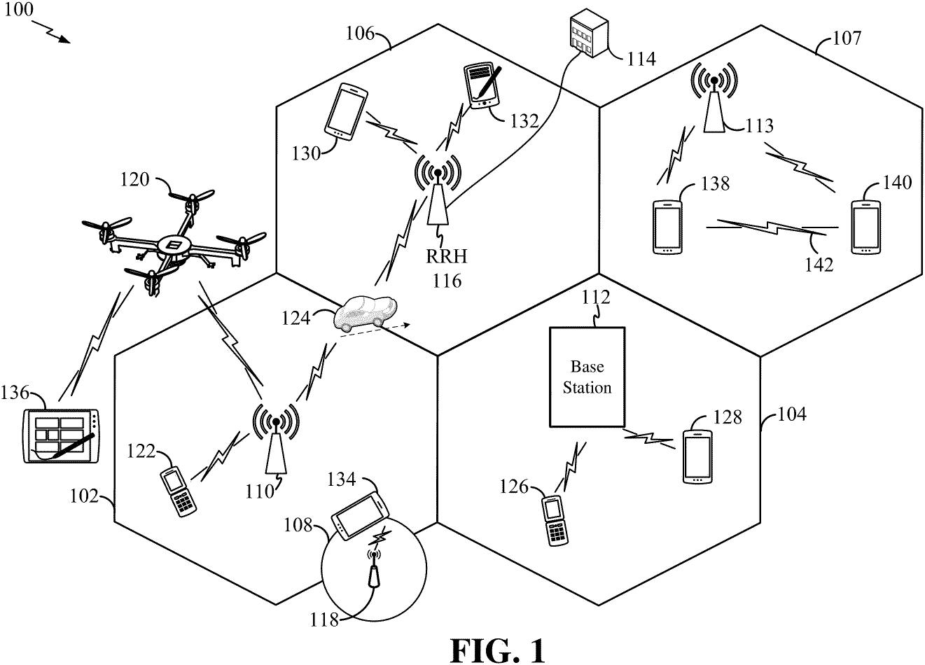

The various concepts presented throughout this disclosure may be implemented across a broad variety of telecommunication systems, network architectures, and communication standards. Referring now to FIG. 1, as an illustrative example without limitation, a schematic illustration of a wireless system 100 of one or more radio access networks (RANs) is provided. The RANs may implement any suitable wireless communication technology or technologies to provide radio access. As one example, a RAN may operate according to 3GPP New Radio (NR) specifications, often referred to as 5G or 5G NR. As another example, a RAN may operate under a hybrid of 5G NR and Evolved Universal Terrestrial Radio Access Network (eUTRAN) standards, often referred to as LTE. 3GPP refers to this hybrid RAN as a next-generation RAN, or NG-RAN. Of course, many other examples may be utilized within the scope of the present disclosure.

The geographic region covered by the one or more radio access networks shown in illustration 100 may be divided into a number of cellular regions (cells) that can be uniquely identified by a user equipment (UE) based on an identification broadcasted over a geographical area from one access point or base station. FIG. 1 illustrates macrocells 102, 104, 106, and 107 and a small cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB) or some other suitable terminology.

In FIG. 1, three base stations 110, 112, and 113 are shown in cells 102, 104, and 107, respectively; and a further base station 114 is shown controlling a remote radio head (RRH) 116 in cell 106. A base station can have an integrated antenna or can be connected to an antenna or RRH by feeder cables. In the illustrated example, the cells 102, 104, 106, and 107 may be referred to as macrocells, as the base stations 110, 112, 113, and 114 support cells having a large size. Further, a base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the base station 118 supports a cell having a relatively small size. Cell sizing can be done according to system design as well as component constraints. It is to be understood that the radio access network 100 may include any number of wireless base stations and cells. Further, a relay node may be deployed to extend the size or coverage area of a given cell. The base stations 110, 112, 113, 114, and 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion (not shown in this figure) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The one or more RANs shown in illustration of wireless system 100 are illustrated supporting wireless communication for multiple mobile apparatuses. A mobile apparatus is commonly referred to as user equipment (UE) in standards and specifications promulgated by 3GPP, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some nonlimiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

The cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; UEs 138 and 140 may be in communication with base station 113, as well as with each other over a sidelink (SL) 142; and UE 136 may be in communication with mobile base station 120. Here, each base station 110, 112, 113, 114, 118, and 120 may be configured to provide an access point to a core network (not shown) for all the UEs in the respective cells. In another example, a mobile network node (e.g., quadcopter 120) may be configured to function as a UE. For example, the quadcopter 120 may operate within cell 102 by communicating with base station 110.

Wireless communication between a RAN and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a base station (e.g., base stations 110, 112, or 113). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a UE (e.g., UE 122).

According to aspects, DL transmissions may include unicast or broadcast transmissions of control information and/or data (e.g., user data traffic or other type of traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

The air interface in the one or more radio access networks of FIG. 1 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the radio access networks of FIG. 1 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In the wireless system 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In various aspects of the disclosure, a RAN 100 may utilize DL-based mobility or UL-based mobility to enable mobility and handovers (i.e., the transfer of a UE’s connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each UE may be utilized by the network to select a serving cell for each UE. In some examples, the base stations 110, 112, 113, or 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, 132, 138, and 140 may receive the unified synchronization signals, derive the carrier frequency and radio frame timing from the synchronization signals, and in response to deriving timing, transmit an uplink pilot or reference signal. The uplink pilot signal transmitted by a UE (e.g., UE 124) may be concurrently received by two or more cells (e.g., base stations 110 and 114/116) within the RAN 100. Each of the cells may measure a strength of the pilot signal, and the RAN (e.g., one or more of the base stations 110 and 114/116 and/or a central node within the core network) may determine a serving cell for the UE 124. As the UE 124 moves through the RAN 100, the network may continue to monitor the uplink pilot signal transmitted by the UE 124. When the signal strength or quality of the pilot signal measured by a neighboring cell exceeds that of the signal strength or quality measured by the serving cell, the RAN 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the one or more RANs in wireless system 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In order for transmissions over the RANs in wireless system 100 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In early 5G NR specifications, data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

However, those of ordinary skill in the art will understand that aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

In some examples, access to the air interface may be scheduled, wherein a scheduling entity (e.g., a base station 113) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, a UE 138, which may be a scheduled entity, may utilize resources allocated by the base station or scheduling entity 113.

Base stations are not the only entities that may function as a scheduling entity. That is, in some examples, a UE may function as a scheduling entity, scheduling resources for one or more scheduled entities (e.g., one or more other UEs). In other examples, two or more UEs (e.g., UEs 138 and 140) may communicate with each other using sidelink signals 142 without conveying that communication through a base station (e.g., base station 113) and without necessarily relying on scheduling or control information from a base station.

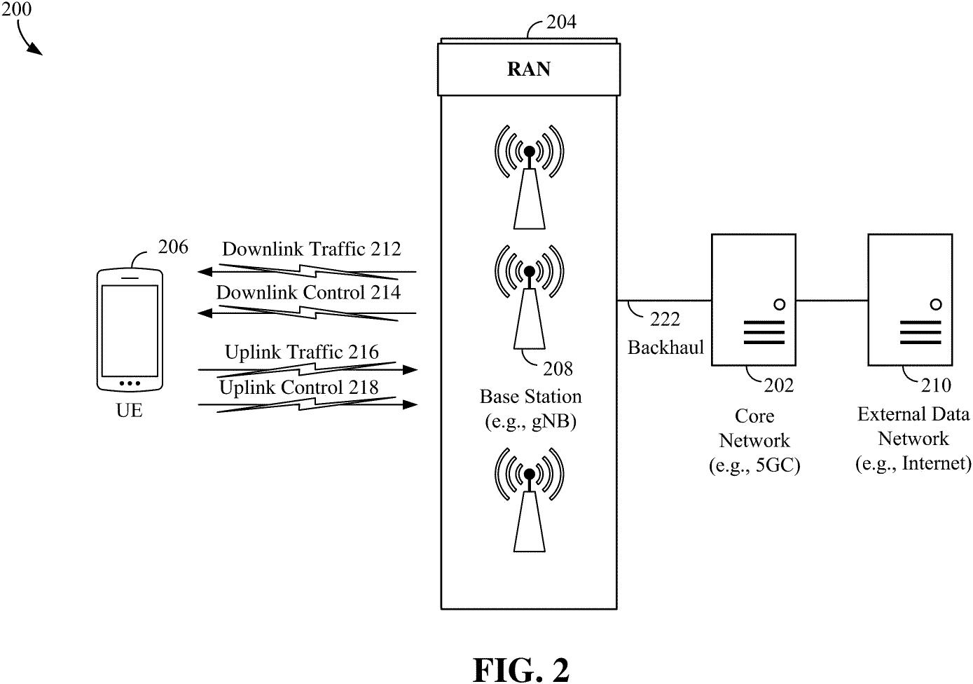

FIG. 2, as another illustrative example without limitation, illustrates various aspects of the present disclosure are illustrated with reference to a wireless communication system 200. The wireless communication system 200 includes three interacting domains: a core network 202, a radio access network (RAN) 204, and at least one user equipment (UE) 206. By virtue of the wireless communication system 200, the UE 206a may be enabled to carry out data communication with an external data network 210, such as (but not limited to) the Internet.

The RAN 204 may implement any suitable wireless communication technology or technologies to provide radio access to the UE 206. As one example, the RAN 204 may operate according to 5G NR. As another example, the RAN 204 may operate under a hybrid of 5G NR and Evolved Universal Terrestrial Radio Access Network (eUTRAN) standards, often referred to as LTE, such as in non-standalone (NSA) systems including EN-DC systems. The 3GPP also refers to this hybrid RAN as a next-generation RAN, or NG-RAN. Additionally, many other examples may be utilized within the scope of the present disclosure.

As illustrated in FIG. 2, the RAN 204 includes a plurality of base stations 208. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

Wireless communication between the RAN 204 and a UE 206 may be described as utilizing an air interface. Transmissions over the air interface from the base station (e.g., base station 208) to the UE 206 may be referred to as downlink (DL) transmission. In accordance with certain aspects of the present disclosure, the term downlink may refer to a point-to-multipoint transmission originating at a scheduling entity (e.g., base station 108). Another way to describe this scheme may be to use the term broadcast channel multiplexing. Transmissions from UE 206 to a base station (e.g., base station 208) may be referred to as uplink (UL) transmissions. In accordance with further aspects of the present disclosure, the term uplink may refer to a point-to-point transmission originating at a UE (e.g., UE 206).

In some examples, access to the air interface may be scheduled, wherein a scheduling entity (e.g., a base station 208) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UE 206, which may be a scheduled entity, may utilize resources allocated by the scheduling entity 208.

As illustrated in FIG. 2, a base station or scheduling entity 208 may broadcast downlink traffic 212 to one or more scheduled entities (e.g., UE 206). Broadly, the base station or scheduling entity 208 may be configured as a node or device responsible for scheduling traffic in a wireless communication network, including the downlink traffic 212 and, in some examples, uplink traffic 216 from one or more scheduled entities (e.g., UE or scheduled entity 206) to the scheduling entity 208. The UE or scheduled entity 206 may be configured as a node or device that also receives downlink control information 214, including but not limited to scheduling information (e.g., a grant), synchronization or timing information, or other control information from another entity in the wireless communication network such as the scheduling entity 208. Furthermore, the UE 206 may send uplink control information 218 to the base station 208 including, but not limited to, scheduling information (e.g., grants), synchronization or timing information, or other control information.

In general, base stations 208 may include a backhaul interface for communication with a backhaul portion 222 of the wireless communication system. The backhaul 222 may provide a link between a base station 208 and the core network 202. Further, in some examples, a backhaul network may provide interconnection between the respective base stations 208. Various types of backhaul interfaces may be employed, such as a direct physical connection, a virtual network, or the like using any suitable transport network.

The core network 202 may be a part of the wireless communication system 200, and may be independent of the radio access technology used in the RAN 204. In some examples, the core network 202 may be configured according to 5G standards (e.g., 5GC). In other examples, the core network 202 may be configured according to a 4G evolved packet core (EPC), or any other suitable standard or configuration.

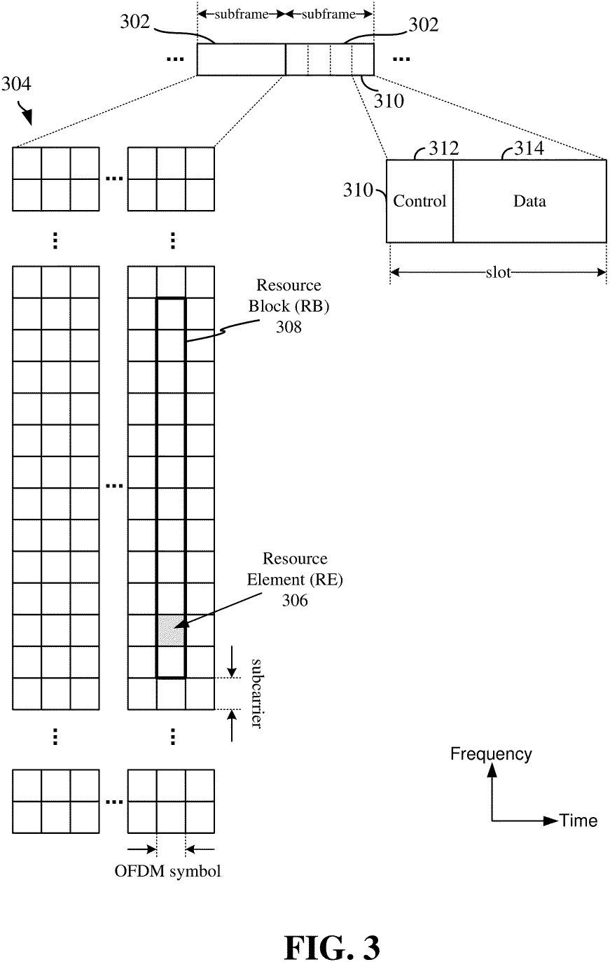

Various aspects of the present disclosure will be described with reference to an OFDM waveform, schematically illustrated in FIG. 3. It should be understood by those of ordinary skill in the art that the various aspects of the present disclosure may be applied to other waveforms such as an SC-FDMA waveform in substantially the same way as described below. While some examples in FIG. 3 of the present disclosure may focus on an OFDM link for clarity, it should be understood that the same principles may be applied to other waveforms.

The channels or carriers described above in connection with FIGS. 1 and 2 are not necessarily all of the channels or carriers that may be utilized between a base station or scheduling entity and UEs or scheduled entities, and those of ordinary skill in the art will recognize that other channels or carriers may be utilized in addition to those illustrated, such as other traffic, control, and feedback channels.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier × 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs (e.g., scheduled entities) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station or may be self-scheduled by a UE implementing D2D or relay sidelink communication.

In this illustration, the RB 308 is shown as occupying less than the entire bandwidth of the subframe 302, with some subcarriers illustrated above and below the RB 308 in frequency. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 2, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast or unicast communication. For example, a broadcast or multicast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In a DL transmission, the transmitting device may allocate one or more REs 306 (e.g., within a control region 312) to carry DL control information including one or more DL control channels, such as a PBCH; a PSS; a SSS; a physical control format indicator channel (PCFICH); a physical hybrid automatic repeat request (HARQ) indicator channel (PHICH); and/or a physical downlink control channel (PDCCH), etc., to one or more scheduled entities. The PCFICH provides information to assist a receiving device in receiving and decoding the PDCCH. The PDCCH carries downlink control information (DCI) including but not limited to power control commands, scheduling information, a grant, and/or an assignment of REs for DL and UL transmissions. The PHICH carries HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In an UL transmission, the transmitting device may utilize one or more REs 306 to carry UL control information including one or more UL control channels, such as a physical uplink control channel (PUCCH), to the scheduling entity. UL control information may include a variety of packet types and categories, including pilots, reference signals, and information configured to enable or assist in decoding uplink data transmissions. In some examples, the control information may include a scheduling request (SR), i.e., request for the scheduling entity to schedule uplink transmissions. Here, in response to the SR transmitted on the control channel, the scheduling entity may transmit downlink control information that may schedule resources for uplink packet transmissions. UL control information may also include HARQ feedback, channel state feedback (CSF), or any other suitable UL control information.

In addition to control information, one or more REs 306 (e.g., within the data region 314) may be allocated for user data traffic. Such traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry system information blocks (SIBs), carrying information that may enable access to a given cell.

Concerning power control for uplink transmissions, it is noted that for the physical uplink shared channel (PUSCH), the transmission power may be determined according to known conditions. In particular, if a UE transmits the PUSCH on an active UL bandwidth part (BWP) b of a carrier f of a serving cell c, and using a parameter set configuration with index j and PUSCH power control adjustment state with index l, the UE determines the PUSCH transmission power for a PUSCH transmission occasion i according to the following relationship:

$$\begin{matrix}{P}_{P U S C H} \left(i , j , {q}_{d} , l\right) \\ = min \left(\begin{matrix}{P}_{c m a x , f , c \left(i\right)} \\ {P}_{{o}_{P U S C H} , b , f , c} \left(j\right) + 10 {log}_{10} \left({2}^{μ} {M}_{R B , b , f , c}^{P U S C H} \left(i\right)\right) + {α}_{b , f , c ,} \left(j\right) P {L}_{b , f , c} \left({q}_{d}\right) + {Δ}_{T F , f , c} \left(i\right) + {f}_{b , f , c} \left(i , l\right)\end{matrix}\right)\end{matrix}$$

where P_{o_{PUSCH},b,f,c} is the target SINR determined by P0 value, is the bandwidth of the PUSCH resource assignment expressed in a number of resource blocks for the PUSCH transmission, α_{b},_{f},_{c}, is path loss compensation factor, PL_{b}_{,}_{f,c} is path loss downlink RS, Δ_{TF,f,c} is MCS related adjustment, and f_{b},_{f},_{c} is the PUSCH power control adjustment state with a value closeloopindex l. This determination is limited, however, by a predetermined maximum transmit power limit P_{Cmax,f,c(i)} as shown in the relationship above.

In some examples, DCI format DCI format 2_2 is typically used for the transmission of TPC commands for the PUCCH and PUSCH channels on the uplink. Additionally, information transmitted by DCI format 2_2 is cyclic redundancy check (CRC) scrambled by a TPC-PUSCH-RNTI or a TPC-PUCCH-RNTI. Furthermore, the DCI 2_2 transmission may include blocks numbered block 0 through block N, each of which may contain a respective TPC command in some examples. The parameter tpc-Index, which is provided by higher layers, determines the index to the block number for UL transmissions of a cell. Each block includes various information including a closed loop indicator (which may be a single bit having a value of 0 or 1). Additionally, for DCI format 2_2 scrambled with TPC-PUSCH-RNTI, a 0 value bit may be indicated in the block if the UE is not configured with a high layer parameter twoPUSCH-PC-AdjustmentStates, in which case a UE assumes each block in the DCI format 2_2 is two bits. Otherwise, the bit value is 1 and the UE assumes each block in the DCI format 2_2 is three bits.

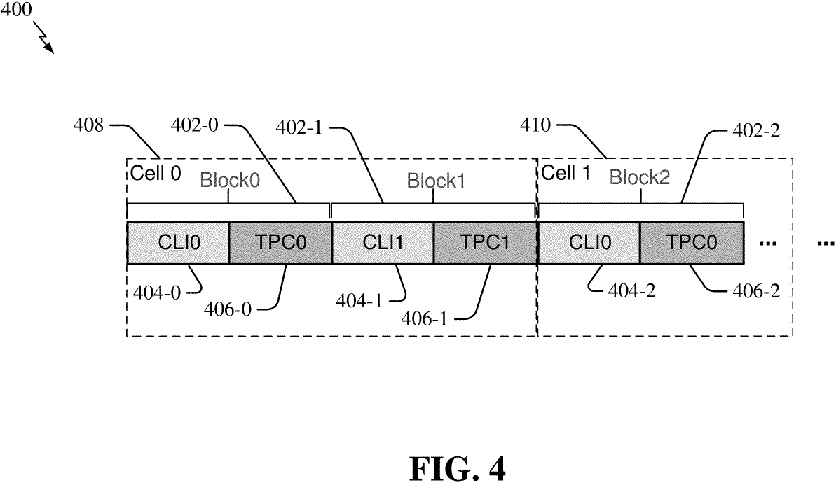

FIG. 4 illustrates an example of blocks of downlink control information (DCI) 400 according to certain aspects. In this illustration, three blocks 402-0, 402-1, and 402-2 are shown of the N number of blocks in the DCI 400. Within each block 402 is a closed loop indicator CLI 404 (e.g., 404-0 denoting CLI0 for block 0 402-0, 404-1 denoting CLI1 for block 1 402-1, and so forth) and transmit power control information TPC 406 (e.g., 406-0 denoting TCP0 for block 0 402-0, 406-1 denoting TCP1 for block 1 402-1, and so forth). As further illustrated, blocks 0 and 1 (402-0 and 402-1) are used for a first cell (cell 0) 408. Block 2 404-2 is used for another cell (Cell 1 denoted with reference 410).

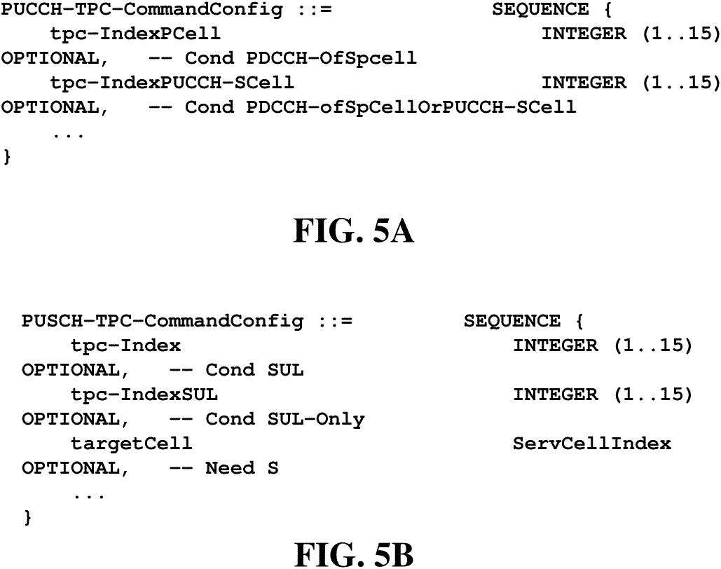

Concerning the RRC configuration, FIGS. 5A and 5B respectively illustrate RRC exemplary configurations for PUCCH TPC commands and PUSCH TPC commands.

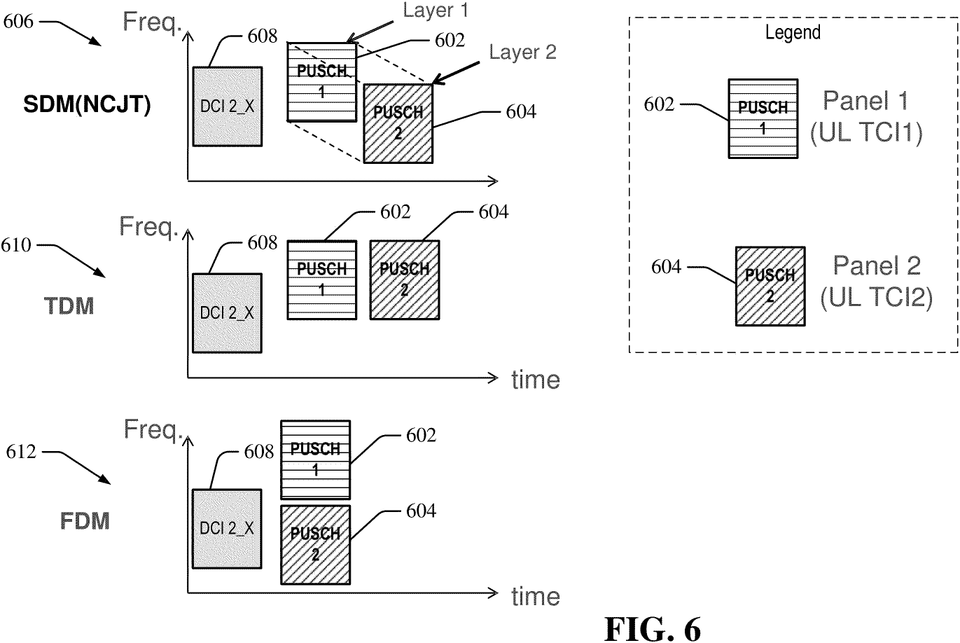

FIG. 6 illustrates exemplary plots of multi-panel transmissions over time for various multiplexing schemes. As shown, a first panel transmission 602 with horizontal line shading is for an uplink transmission of a channel such as PUSCH (also designated PUSCH 1 to indicate the first panel transmission for the PUSCH), but the disclosure is not limited to such and this diagram is applicable for PUCCH as well, as another example. A second panel transmission 604 with diagonal line shading is also for the uplink transmission of the channel such as PUSCH (also designated PUSCH 2 to indicate the second panel transmission for the PUSCH). Additionally, these panels may have been identified with a respective transmission configuration indicator (TCI) (e.g., TCI1 and TCI2). A panel can also be identified as an antenna port group. For codebook based MIMO schemes, the panel can also be identified by the sounding reference signal (SRS) resource indicator (SRS resource ID). For non-codebook based MIMO schemes, the panel can also be identified by the sounding reference signal (SRS) resource set indicator (SRS resource set ID).

In a first example 606, a spatial division multiplexing (SDM) scheme (or non-coherent joint transmission (NCJT)) is shown. Here, on the downlink (DL), a DCI 608 configured under a type 2 format (Format 2_x) is first transmitted from a gNB or scheduling entity to a UE or scheduled entity. On the UL, the UE transmits with multiple panels in different spatial layers; namely panel 1 602 in layer 1 and panel 2 604 in layer 2.

In another example 610, a time division multiplexing (TDM) scheme is illustrated wherein after the DCI 608 is transmitted on the DL to a UE or scheduled entity, the multiple panels 602 and 604 are utilized for UL transmissions at different times. In still another example 612, a frequency division multiplexing (FDM) scheme is illustrated wherein after the DCI 608 is transmitted on the DL to a UE or scheduled entity, the multiple panels 602 and 604 are utilized for UL transmissions at the same time but using different subcarriers or frequencies.

The present disclosure therefore provides for a per-panel TPC configuration and indication in a group common DCI for multi-panel uplink transmissions. As will be discussed below, various disclosed options to effectuate the per-panel TPC configuration and indication may include an explicit panel ID indication in the DCI, an RRC configuration where two TPC blocks in the DCI are configured for a particular cell, or using two or more DCIs in common search spaces where each DCI is configured to include TPC associated with a respective panel.

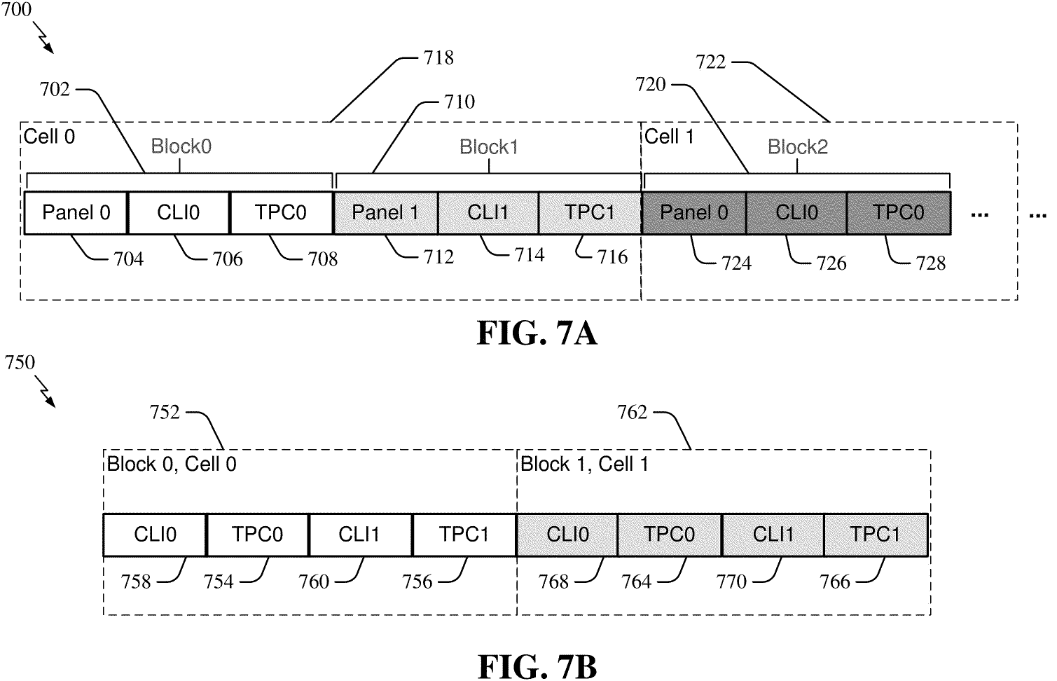

Turning to FIG. 7A, this figure illustrates an exemplary configuration of a group common DCI 700 that provides an indication of a panel identifier within the DCI. It is noted that while this example illustrates a group common DCI format such as Format 2_2 or, more generally, a Format 2_x, this is merely exemplary and not meant to be limiting.

The group common DCI 700 may be CRC scrambled by TPC-PUSCH-RNTI for a PUSCH channel or TPC-PUCCH-RNTI for a PUCCH channel. Information that may be transmitted includes transmission within blocks 1-N. Additionally, a parameter tpc-PUSCH or tpc-PUCCH provided at higher layers in the OSI model determines the index to the block number for an UL transmission of a cell. In further aspects, the group common DCI 700 may include a number of fields that are defined for each block if configured with “multi-UL-panel”, which is a higher level configuration denoting that UL transmission is configured for multi-panel transmission in the uplink. As shown in FIG. 7, the DCI 700 includes a block 0 at 702 that includes an additional panel identifier (Panel ID) field 704, along with the closed loop indicator field 706 and the TPC information field 708. In one implementation, the panel ID may be a single, explicit bit where a bit value of zero in this field 704 will indicate that the TPC information (i.e., TPC0 at 708) in the block 702 is for a first panel transmission. Alternatively, a Panel ID bit value of one in field 704 (or field 712 in block 1 710) indicates that the TPC information in that block is the TPC information for a second panel transmission. In still further aspects, the closed loop indicator CLI may be a single bit field and the TPC command may be 2 bits (i.e., 4 states or values that may be mapped to predetermined values used for transmit power control in the UE for the UL transmissions per panel transmission).

As illustrated, a second block (block1 710) includes the same fields; namely Panel ID field 712, CLI field 714, and TPC field 716). Of further note, the DCI may be configured here such that two blocks (e.g., block0 702 and block1 710) are used for indicating TPC information for two panels in a cell (e.g., Cell 0 shown at 718) assuming a two panel UL transmission system, but those skilled in the art will appreciate that the disclosure is not limited to such and the concepts herein could be scaled to systems beyond two panels.

FIG. 7A further illustrates that the DCI includes further blocks for additional cells (e.g., Cell 1 at 722) and as shown by block 2 720, fields 724, 726, and 728. It is noted that the Cell 0 and the Cell 1 may be associated with the same UE or different UEs.

FIG. 7B illustrates a DCI 750 indicating a panel identification according to a second option where the panel ID field of the example in FIG. 7A is not utilized. In this example, the DCI 750 is configured such that a block includes two consecutive TPC sub-blocks (e.g., e.g., TPC0 754 and TPC1 756) providing TPC information for two respective panels. In this example, the block 0 (752) includes two CLIs 758 and two TPC sub-blocks 754 and 756 (i.e., the number of bits enables two fields of CLI and TPC indications) corresponding to the TPC information for a cell (cell 0) supporting multi-panel UL transmissions.

The use of the two consecutive TPC sub-blocks or fields (754, 756) affords a per panel TPC configuration. Additionally, the use of two consecutive blocks is able to provide an indication of panels with the DCI as the panel identification scheme is known a priori from an RRC configuration in the UE, for example. That is, the UE is configured to recognize that two consecutive sub-blocks in a block will provide respective first and second panel TPC information. While the order shown in TPC0 and TPC1 is for respective first and second panels, it is evident that this order could be reversed and that the more salient feature is the consecutive transmission of two TPC blocks to indicate the TPC information for two UL panel transmissions.

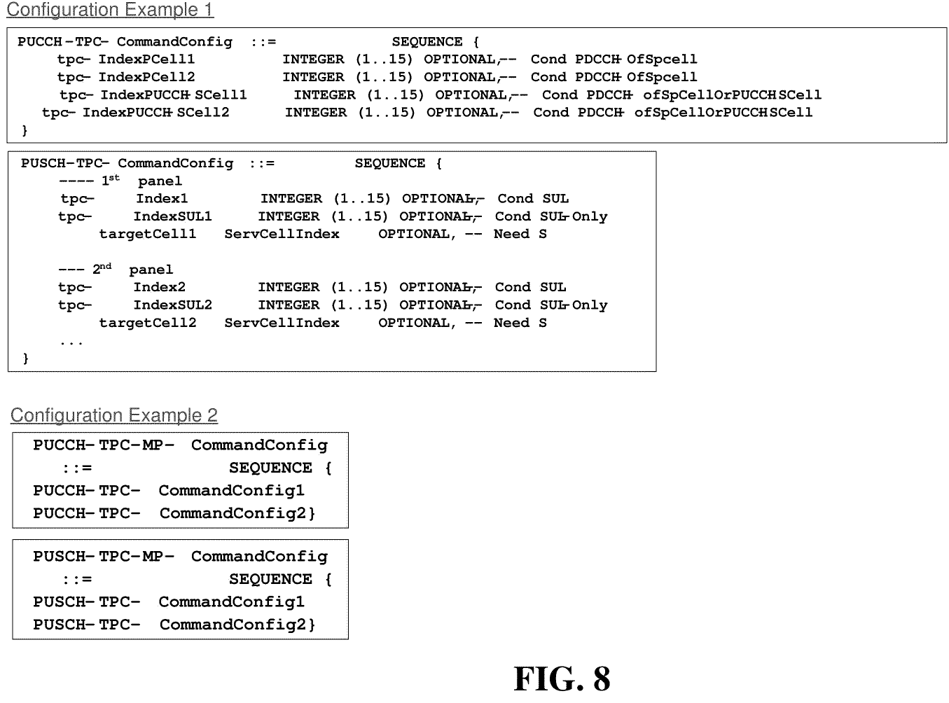

According to further aspects of the present disclosure, the radio resource control (RRC) layer can be used to configure two TPC blocks in the DCI for a particular cell to provide a per-panel TPC configuration and indication. Here, the structure of the DCI would be the same as shown in FIG. 4, where each block (e.g., 402) contains a CLI (e.g., 404) and TPC information (e.g., 406)., and two blocks may be used to indicate information for a cell (e.g., cell 0 as shown at 408). In particular, the indication of a panel ID may be supported in the TPC-PUxCH-commandconfig within the RRC configuration, which is either for TPC-PUCCH-commandconfig or TPC-PUSCH-commandconfig. In particular, a UE can be configured with two TPC blocks for a cell in a group common DCI (format 2_x), which are used for the transmission of TPC commands for PUCCH and PUSCH in two panels. Exemplary RRC configurations that may be utilized are illustrated in FIG. 8, which shows two examples of RRC configurations.

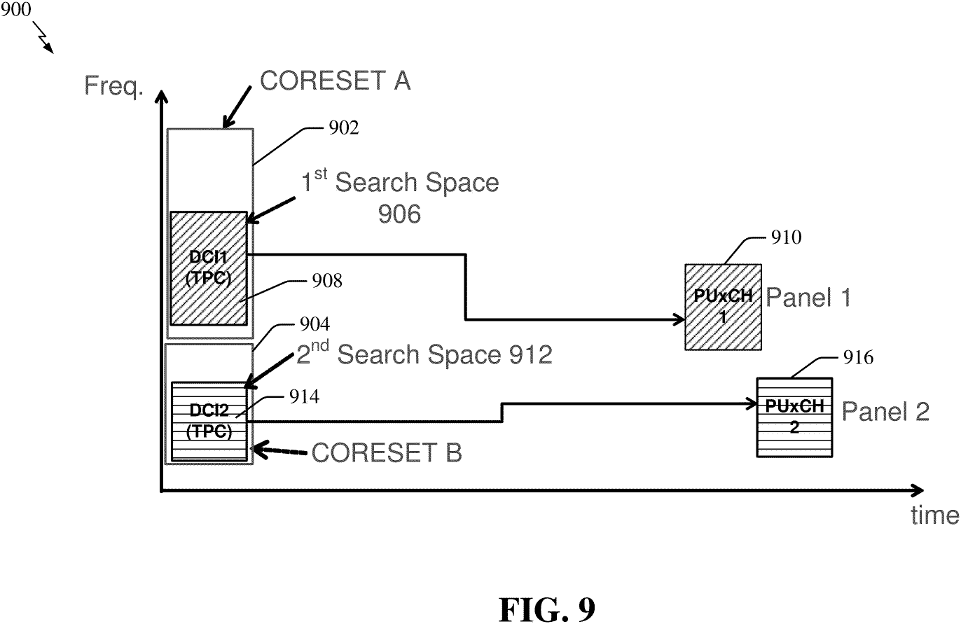

FIG. 9 illustrates a time/frequency plot 900 of another example using multiple DCI (m-DCI) for scheduling a multi-panel uplink transmission according to yet further aspects. In this example, each DCI is associated with a respective different set of physical resources in the downlink resource grid (i.e., frequency/time grid) as shown. In one example, the physical resources include at least two different control resource sets (CORESETs) with respective indexes (e.g., CORESETpoolindex). This association of a DCI to a corresponding CORESET (and its index), in turn, may be used to provide an indication of a particular UL panel transmission to the UE.

As may be seen in the particular implementation of FIG. 9, a downlink transmission may include a first CORESET 902 (CORESET A) and second CORESET 904 (CORESET B). These CORESETs 902 and 904 may have an associated respective CORESETpoolindex value. A first portion of resources 906 within the first CORESET 902 are allocated for monitoring a first group common DCI 908 by a UE. In particular aspects, the first portion of resources 906 is associated with a first common search space, such as a Type 3 common search space. By virtue of the inclusion of DCI1 908 in search space 906 within CORESET 902, this DCI 908 location or position can be used by a UE to determine that this DCI includes TPC information for a first panel UL transmission 910 shown at a later time from the DL transmission of CORESET 902. In a particular aspect, the CORESET index (e.g., CORESET A’s CORESETpoolindex=0) value may be used as a panel ID that communicates to the UE the particular panel that TPC information in DCI1 902 pertains (e.g., panel 1).

Similarly, a second portion of resources 912 is a second common search space within the second CORESET 904, and are allocated for monitoring a second group common DCI2 914 by a UE. In particular aspects, the second portion of resources 912 is a second common search space, such as a Type 3 common search space. By inclusion of DCI2 912 in search space 912 within CORESET 904, this DCI 912 location or position can be used by a UE to determine that this DCI includes TPC information for a second panel UL transmission 916 shown at a later time from the DL transmission of CORESET 914. Again, in a particular aspect, the CORESET index (e.g., CORESET B’s CORESETpoolindex=1) value may be used as a panel ID that communicates to the UE the particular panel that TPC information in DCI2 914 pertains (e.g., panel 2).

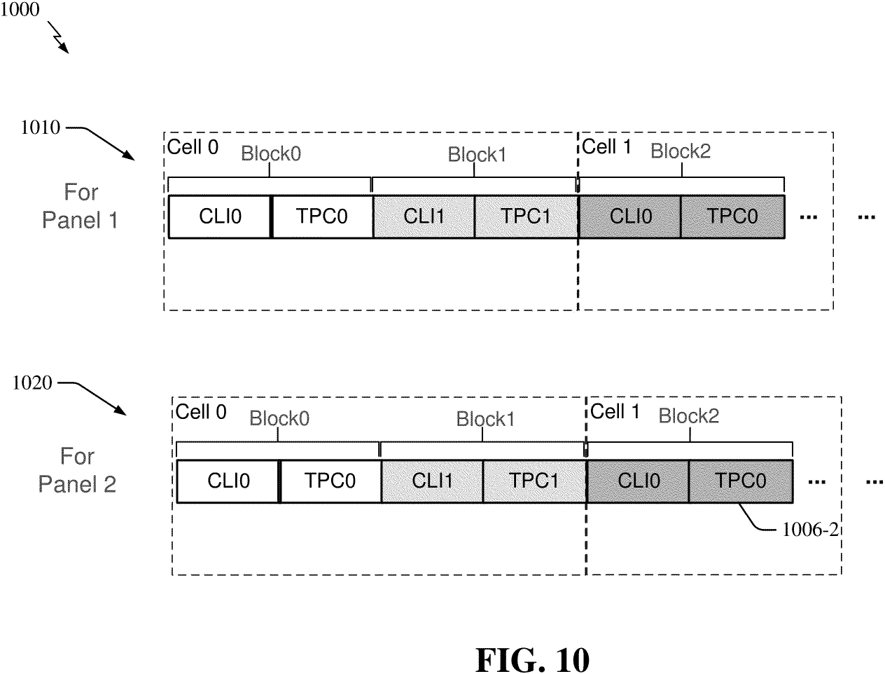

FIG. 10 illustrates an example 1000 of the structure of the group common DCIs used in the example of FIG. 9. In this example, there are multiple DCIs; namely DCI 1020 and DCI 1020 for this two panel example. The DCI structure for each DCI 1010 and 1020 in this example is similar to the structure shown in FIG. 4, where two blocks (Block 0 and Block 1) for each cell include a closed loop indicator CLI0 and the transmit power control command/information TPC0 in block0 and another closed loop indicator CLI1 and the transmit power control command/information TPC1 in block1.

In further aspects, it is noted that the methodology of FIG. 9 may include an alternative where the panel ID is based on a sounding reference signal (SRS). In particular, each panel ID may be based on a sounding reference signal (SRS) Resource ID for an SRS resource set for a codebook based multiple input and multiple output (MIMO) scheme in a respective one of the first or second sets of physical resources in the downlink transmission. In another aspect, each panel ID may be based on a sounding reference signal (SRS) resource set ID for an SRS resource set for a non-codebook based MIMO scheme in a respective one of the first or second sets of physical resources in the downlink transmission.

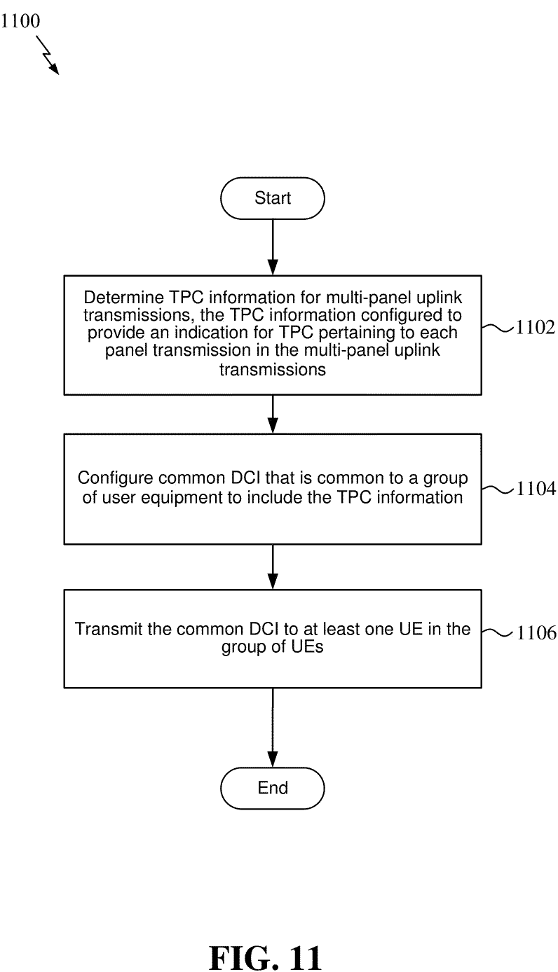

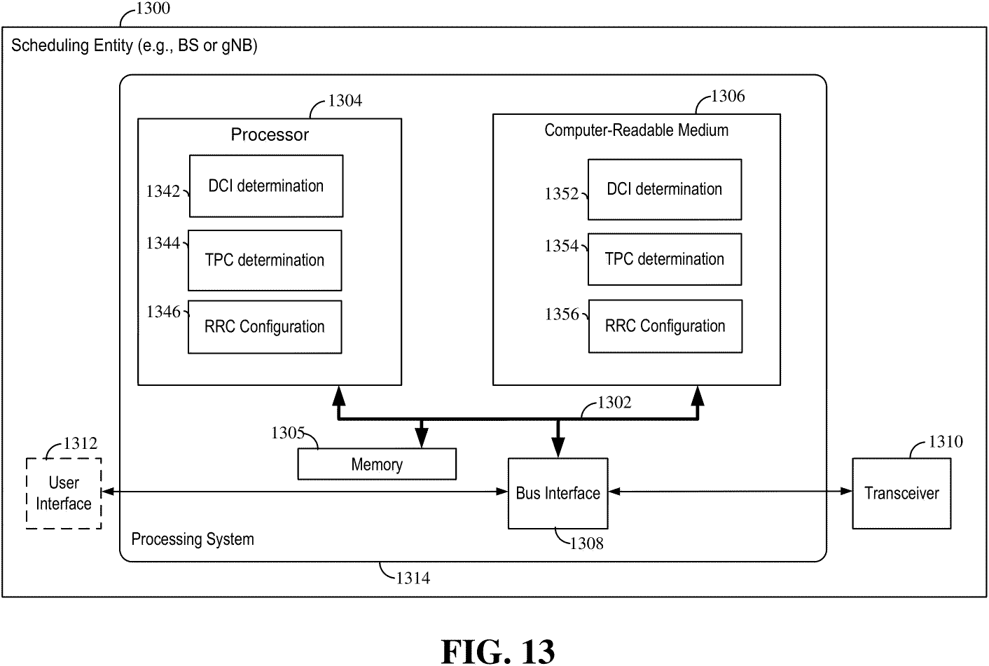

FIG. 11 illustrates an exemplary method 1100 for providing group common downlink control information for transmission power control in a multi-panel uplink transmission. According to aspects, method 1100 may implemented in a scheduling entity, base station, or gNB, such as base stations 110, 112, 113, and 116 in FIG. 1, base station 208 in FIG. 2, or scheduling entity 1300 in FIG. 13, as discussed below. Method 1100 includes determining transport power control (TPC) information for multi-panel uplink transmissions, where the TPC information is configured to provide an indication for TPC pertaining to each panel transmission (i.e., on a per panel basis) in the multi-panel uplink transmission as shown in block 1102.

Method 1100 further includes configuring a group common downlink control information (DCI) that is common to a group of user equipment (UE) to include the determined TPC information as shown in block 1104. The processes of block 1104 may further include configuring the group common DCI in a manner that facilitates the per panel indication such as through the structure of the DCI explicitly indicating a panel ID as in the example of FIG. 7A or a multiple DCI structure as in the example of FIGS. 9 and 10. In other aspects, the DCI configuration processes in block 1104 may include RRC configuration of two TPC blocks in the DCI for a cell such as in the example of FIG. 8. In yet other aspects, the DCI configuration processes of block 1104 may include the explicit structuring of a DCI to include an explicit panel ID indication as shown in the example of FIG. 7A.

Additionally, method 1100 may include transmitting the group common DCI to at least one UE in the group of UEs as shown at block 1106. Of further note, the group common DCI may be transmitted to the UE within particular DCI structures that are configured for each cell (e.g., blocks in the DCI designating one or more cells such as Cell 0 or Cell 1, which may, in turn, be configured as either a primary serving cell (PCell) or secondary serving cell (SCell)) as was illustrated in the examples of FIGS. 4, 5, 7A, 7B, 8, or 10.

In further aspects, method 1100 may include providing at least one panel identification (ID) field in the DCI that correlates a portion of the TPC information to a particular panel transmission of the multi-panel uplink transmissions. Additionally, the panel ID field may be provided in a TPC block in the DCI to correlate the portion of the TPC information to the particular panel transmission (See e.g., FIG. 7A).

In still further aspects, method 1100 may include arranging the TPC information in a TPC block to include at least two consecutive TPC sub-blocks, wherein each sub-block contains a respective portion of the TPC information pertaining to respective panel transmissions of the multi-panel transmissions. An example of this process was discussed previously in connection with FIG. 7B.

Still in further aspects, method 1100 may include that the configuring of the group common DCI includes using radio resource command (RRC) signaling to a UE to designate at least two TPC blocks that are usable for transmission of TPC commands on the multi-panel uplink transmissions for both an uplink control channel and an uplink data channel in at least two panels. An example of this process was discussed previously in connection with FIG. 8.

In more aspects, method 1100 may include configuring the group common DCI to include multiple DCIs each of which is located in respective first and second portions of a downlink transmission each of which is associated with respective first and second sets of physical resources in the downlink transmission, wherein the first portion of the downlink transmission associated with the first set of physical resources indicates a first portion of the TPC information for a first panel and the second portion of the downlink transmission associated with the second set of physical resources indicates a second portion of the TPC information for a second panel. Additionally, in yet further aspects, the first and second portions of the downlink transmission are corresponding common search space sets and the first and second sets of physical resources are corresponding different types of CORESETs in a serving cell. A specific example of this process was discussed previously in connection with FIGS. 9 and 10.

In other aspects of method 1100, it is noted that each CORESET is configured with a corresponding index number, wherein each index number is correlated to a corresponding panel identifier (ID) that identifies a panel of the multi-panel uplink transmissions such that the index number indicates the panel ID. Moreover, method 1100 includes establishing a panel identifier (ID) for each panel transmission of the multi-panel uplink transmissions, wherein each panel ID is based on a sounding reference signal (SRS) Resource set ID for an SRS resource set in a respective one of the first or second sets of physical resources in the downlink transmission. In particular aspects here, the SRS resource set ID used in associated with one of a Non-Code Book multiple input and multiple output (MIMO) usage or a Code Book MIMO usage.

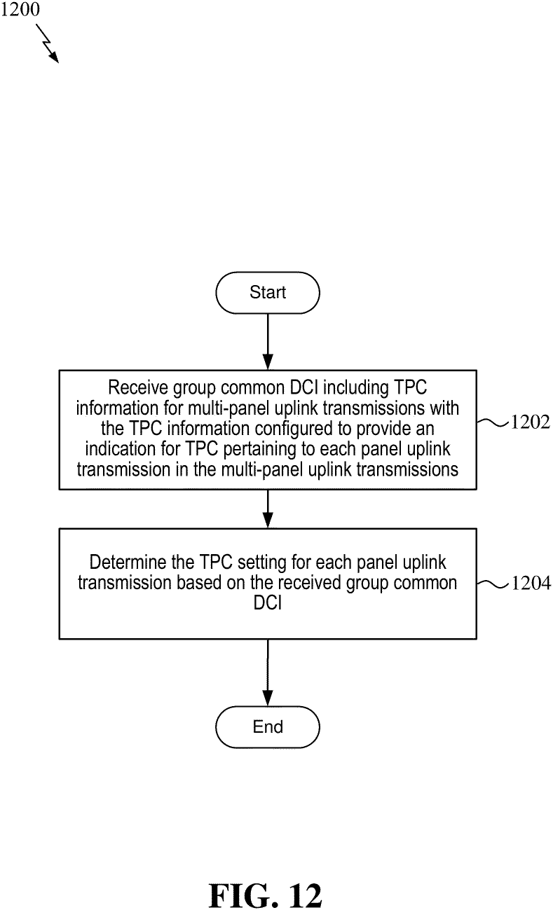

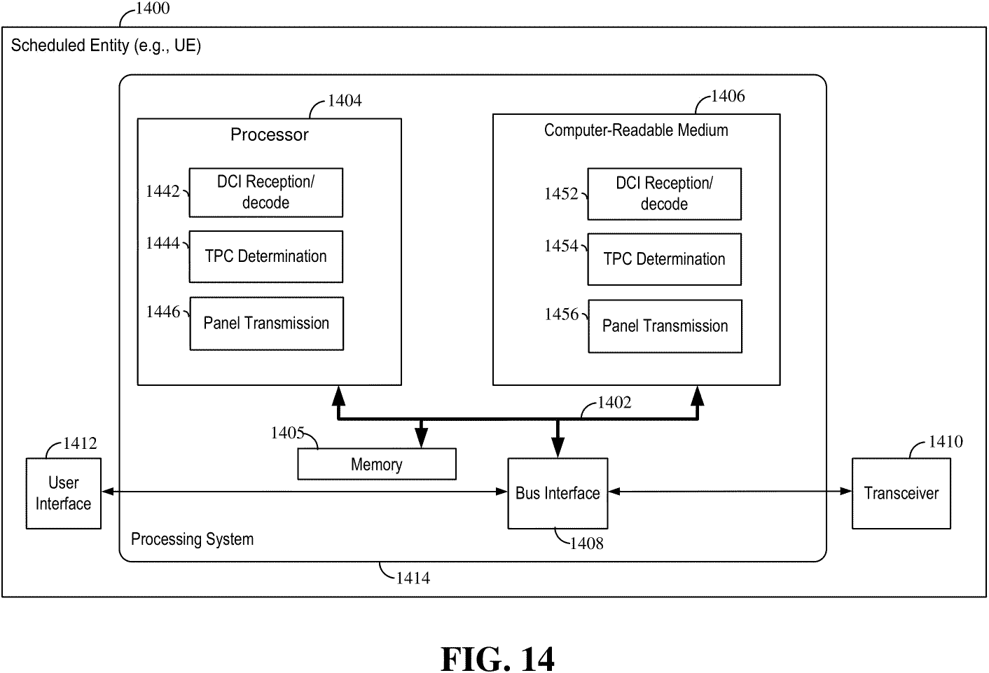

FIG. 12 illustrates an exemplary method 1200 in a scheduled entity or UE for receiving and utilizing group common downlink control information for transmission power control for multi-panel uplink transmissions by the scheduled entity or UE. According to aspects, method 1200 may implemented in a scheduled entity such as a UE as shown by 122, 124, 126, 128, 130, 132, 138, or 140 in FIG. 1, UE 206 in FIG. 2, or scheduled entity 1400 in FIG. 14, as discussed below.

As illustrated in FIG. 12, method 1200 includes receiving, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions as shown in block 1202. After receiving the DCI and TPC information, method 1200 includes determining the TPC setting for each panel uplink transmission based on the received group common DCI as shown at block 1204. Further, method 1200 then includes transmitting each panel uplink transmission to a scheduling entity on uplink channels, such as PUCCH or PUSCH.

Method 1200 further includes receiving the group common DCI including at least one panel identification (ID) field in the DCI that correlates a portion of the TPC information to a particular panel transmission of the multi-panel uplink transmissions. Accordingly, the method then includes, within the scheduled entity, determining the TPC setting for each panel uplink further based on the at least one panel ID. Further, the panel ID field is provided in a TPC block in the DCI to correlate the portion of the TPC information to the particular panel transmission. In another aspect, method 1200 may include that the received TPC information arranged in a TPC block of the group common DCI includes at least two consecutive TPC sub-blocks, wherein each sub-block contains a respective portion of the TPC information pertaining to respective panel transmissions of the multi-panel transmissions. Moreover, method 1200 includes then determining the TPC setting for each panel uplink transmission further based on the at least two consecutive TPC sub-blocks.

In other aspects, method 1200 may include receiving radio resource command (RRC) signaling for setting, within the scheduled entity, at least two TPC blocks that are usable for transmission of TPC commands on the multi-panel uplink transmissions for both an uplink control channel and an uplink data channel in at least two panels. After this, the method 1200 may further include determining the TPC setting for each panel uplink transmission based on the received RRC signaling settings in the scheduling entity.

In yet further aspects, method 1200 may include receiving the group common DCI that is configured to include multiple DCIs respectively located in first and second portions of a downlink transmission each of which is associated with respective first and second sets of physical resources in the downlink transmission, wherein the first portion of the downlink transmission associated with the first set of physical resources indicates a first portion of the TPC information for a first panel and the second portion of the downlink transmission associated with the second set of physical resources indicates a second portion of the TPC information for a second panel. The method 1200 may then include determining within the scheduled entity the TPC setting for each panel uplink transmission based on the indications of the first and second portions of the TPC information. In aspects, the first and second portions of the downlink transmission are corresponding common search space sets and the first and second sets of physical resources are corresponding different types of CORESETs in a serving cell. Additionally, each CORESET may have been configured with a corresponding index number, where each index number is correlated to a corresponding panel identifier (ID) that identifies a panel of the multi-panel uplink transmissions such that the index number indicates the corresponding panel ID. From this, the scheduled entity may then determine the TPC setting for each panel uplink further based on the corresponding panel ID.

FIG. 13 is a block diagram illustrating an example of a hardware implementation for a scheduling entity, base station, or gNB 1300 employing a processing system 1314. The scheduling entity 1300 may correspond to any of the base stations or gNBs previously discussed herein, as examples. In further examples, the scheduling entity 1300 may be an access point (AP) or remote radio head, or an IEEE 802.11 device such as a Wi-Fi access point, gateway, or router in some examples.

The scheduling entity 1300 may be implemented with a processing system 1314 that includes one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the base station device 1300 may be configured to perform any one or more of the functions described herein. That is, the processor 1304, as utilized in the base station 1300, may be used to implement any one or more of the processes and procedures described below.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 links together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further.

A bus interface 1308 provides an interface between the bus 1302 and a wireless transceiver 1310. The wireless transceiver 1310 allows for the scheduling entity 1300 to communicate with various other apparatus over a transmission medium (e.g., air interface). Depending upon the nature of the apparatus, a user interface 1312 (e.g., keypad, display, touch screen, speaker, microphone, control knobs, etc.) may also be provided. Of course, such a user interface 1312 is optional, and may be omitted in some examples.

The processor 1304 is responsible for managing the bus 1302 and general processing, including the execution of software stored on the computer-readable medium 1306. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1304, causes the processing system 1314 to perform the various functions described below for any particular apparatus. The computer-readable medium 1306 and the memory 1305 may also be used for storing data that is manipulated by the processor 1304 when executing software.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. In some examples, the computer-readable medium 1306 may be part of the memory 1305. Those skilled in the art will recognize how best to implement the described functionality presented throughout this disclosure depending on the particular application and the overall design constraints imposed on the overall system.

In some aspects of the disclosure, the processor 1304 may include circuitry configured for various functions. For example, the processor 1304 may include a DCI determination circuitry 1342, which is configured for determining one or more group common DCIs that are configured, among other things, to indicate TPC information for multiple panel UL transmissions as discussed herein. Further, processor 1304 may include TPC determination circuitry 1344 configured to determine the TPC information for multiple UL panel transmission for one or more UEs in one or more cells as discussed herein. The processor 1304 further includes RRC configuration circuitry 1346 that is configured to effect RRC control and signaling in connection with the methods discussed earlier such as with respect to FIG. 8, as an example.

The computer-readable medium 1306 includes DCI determination software/instructions 1352 and TPC determination software/instructions 1354 to assist the DCI determination circuitry 1342 and TPC determination circuitry 1344 in performing their respective functions as described herein. Similarly, the computer-readable medium 1306 includes RRC control software/information 1356 to assist the RRC configuration circuitry 1346 perform its function as described herein.

FIG. 14 is a block diagram illustrating an example of a hardware implementation for a wireless communication device 1400 employing a processing system 1414. For example, the wireless communication device 1400 may be a scheduled entity that corresponds to a UE as shown and described above in reference to FIGS. 1 and 2, including UEs 122, 124, 126, 128, 130, 132, 138, or 140 in FIG. 1, and UE 206 in FIG. 2.

The wireless communication device 1400 may be implemented with a processing system 1414 that includes one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1400 may be configured to perform any one or more of the functions described herein. That is, the processor 1404, as utilized in the wireless communication device 1400, may be used to implement any one or more of the processes and procedures described below.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 links together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further.

A bus interface 1408 provides an interface between the bus 1402 and a transceiver 1410. The transceiver 1410 provides a means for communicating with various other apparatus over a transmission medium (e.g., air interface). Depending upon the nature of the apparatus, a user interface 1412 (e.g., keypad, display, touch screen, speaker, microphone, control knobs, etc.) may also be provided. Of course, such a user interface 1412 is optional, and may be omitted in some examples.

The processor 1404 is responsible for managing the bus 1402 and general processing, including the execution of software stored on the computer-readable medium 1406. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1404, causes the processing system 1414 to perform the various functions described below for any particular apparatus. The computer-readable medium 1406 and the memory 1405 may also be used for storing data that is manipulated by the processor 1404 when executing software.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. In some examples, the computer-readable medium 1406 may be part of the memory 1405. Those skilled in the art will recognize how best to implement the described functionality presented throughout this disclosure depending on the particular application and the overall design constraints imposed on the overall system.

In some aspects of the disclosure, the processor 1404 may include circuitry configured for various functions. For example, the processor 1404 may include a DCI reception/decoding circuitry 1442, which is configured to receive the group common DCI from a scheduling entity (e.g., scheduling entity 1300 in FIG. 13) and determine therefrom to which UL transmission panels the TPC information contained within the DCI pertains.

The processor 1404 may further include TPC determination circuitry 1444, configured to determine the TPC settings for the multi-panel transmissions, which may be transmitted by transceiver 1410. Additionally, processor 1404 may include a panel transmission circuitry 1446 that is configured to determine the panel transmissions. In an aspect, the TPC determination circuitry 1444 and the panel transmission circuitry 1446 may interface with each other to determine the appropriate transmission power for the UL panel transmissions, as well as interface with transceiver 1410.

The computer-readable medium 1406 includes DCI reception/decoding software/instructions 1452 and TPC determination software/instructions 1454 to assist the DCI reception/decoding circuitry 1442 and TPC determination circuitry 1444 in performing their respective functions as described herein. Similarly, the computer-readable medium 1406 includes panel transmission software/information 1456 to assist the panel transmission circuitry 1446 perform its function as described herein.

One or more of the components, steps, features, and/or functions illustrated in FIGS. 1-14 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1, 2, 13, or 14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication in a wireless communication network, the method comprising, at a scheduling entity:
determining transport power control (TPC) information for multi-panel uplink transmissions, the TPC information configured to provide an indication for TPC pertaining to each panel transmission in the multi-panel uplink transmissions;
configuring a group common downlink control information (DCI) that is common to a group of user equipment (UE) to include the TPC information; and
transmitting the group common DCI to at least one UE in the group of UEs.

2. The method of claim 1, wherein configuring the group common DCI further comprises:
providing at least one panel identification (ID) field in the DCI that correlates a portion of the TPC information to a particular panel transmission of the multi-panel uplink transmissions.

3. The method of claim 2, wherein the panel ID field is provided in a TPC block in the DCI to correlate the portion of the TPC information to the particular panel transmission.

4. The method of claim 1, wherein configuring the group common DCI further comprises:
arranging the TPC information in a TPC block to include at least two consecutive TPC sub-blocks, wherein each sub-block contains a respective portion of the TPC information pertaining to respective panel transmissions of the multi-panel transmissions.

5. The method of claim 1, wherein configuring the group common DCI further comprises:
using radio resource command (RRC) signaling to a UE to designate at least two TPC blocks that are usable for transmission of TPC commands on the multi-panel uplink transmissions for both an uplink control channel and an uplink data channel in at least two panels.

6. The method of claim 1, further comprising:
configuring the group common DCI to include multiple group common DCIs respectively located in first and second portions of a downlink transmission each of which is associated with respective first and second sets of physical resources in the downlink transmission, wherein the first portion of the downlink transmission associated with the first set of physical resources indicates a first portion of the TPC information for a first panel and the second portion of the downlink transmission associated with the second set of physical resources indicates a second portion of the TPC information for a second panel.

7. The method of claim 6, wherein the first and second portions of the downlink transmission are corresponding common search space sets and the first and second sets of physical resources are corresponding different types of CORESETs in a serving cell.

8. The method of claim 7, wherein each CORESET of the different types of CORESETs is configured with a corresponding index number, wherein each index number is correlated to a corresponding panel identifier (ID) that identifies a panel of the multi-panel uplink transmissions such that the index number indicates the corresponding panel ID.

9. The method of claim 7, further comprising:
establishing a panel identifier (ID) for each panel transmission of the multi-panel uplink transmissions, wherein each panel ID is based on a sounding reference signal (SRS) resource ID for an SRS resource set for a codebook based multiple input and multiple output (MIMO) scheme in a respective one of the first or second sets of physical resources in the downlink transmission.

10. The method of claim 7, further comprising:
establishing a panel identifier (ID) for each panel transmission of the multi-panel uplink transmissions, wherein each panel ID is based on a sounding reference signal (SRS) resource set ID for an SRS resource set for a non-codebook based MIMO scheme in a respective one of the first or second sets of physical resources in the downlink transmission.

11. A wireless communication device, comprising:
a processor;
a wireless transceiver communicatively coupled to the processor; and
a memory communicatively coupled to the processor, wherein the processor and the memory are configured to:
determine, within a scheduling entity, transport power control (TPC) information for multi-panel uplink transmissions, the TPC information configured to provide an indication for TPC pertaining to each panel transmission in the multi-panel uplink transmissions;
configure a group common downlink control information (DCI) that is common to a group of user equipment (UE) to include the TPC information; and
transmit the group common DCI to at least one UE in the group of UEs.

12. A wireless communication device in a wireless communication network, comprising:
means for determining, in a scheduled entity, transport power control (TPC) information for multi-panel uplink transmissions, the TPC information configured to provide an indication for TPC pertaining to each panel transmission in the multi-panel uplink transmissions;
means for configuring a group common downlink control information (DCI) that is common to a group of user equipment (UE) to include the TPC information; and
means for transmitting the group common DCI to at least one UE in the group of UEs.

13. An article of manufacture for use by a wireless communication device in a wireless communication network, the article comprising:
a computer-readable medium having stored therein instructions executable by one or more processors of the wireless communication device to:
determine, within a scheduling entity, transport power control (TPC) information for multi-panel uplink transmissions, the TPC information configured to provide an indication for TPC pertaining to each panel transmission in the multi-panel uplink transmissions;
configure a group common downlink control information (DCI) that is common to a group of user equipment (UE) to include the TPC information; and
transmit the group common DCI to at least one UE in the group of UEs.

14. A method of wireless communication in a wireless communication network, the method comprising:
receiving, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions; and
determining the TPC setting for each panel uplink transmission based on the received group common DCI.

15. The method of claim 14, further comprising:
transmitting each panel uplink transmission to a scheduling entity on uplink channels.

16. The method of claim 14, further comprising:
the group common DCI comprises at least one panel identification (ID) field in the DCI that correlates a portion of the TPC information to a particular panel transmission of the multi-panel uplink transmissions; and
determining the TPC setting for each panel uplink further based on the at least one panel ID.

17. The method of claim 16, wherein the panel ID field is provided in a TPC block in the DCI to correlate the portion of the TPC information to the particular panel transmission.

18. The method of claim 14, further comprising:
the received TPC information arranged in a TPC block of the group common DCI to include at least two consecutive TPC sub-blocks, wherein each sub-block contains a respective portion of the TPC information pertaining to respective panel transmissions of the multi-panel transmissions; and
determining the TPC setting for each panel uplink further based on the at least two consecutive TPC sub-blocks.

19. The method of claim 14, further comprising:
receiving radio resource command (RRC) signaling setting, within the scheduled entity, at least two TPC blocks that are usable for transmission of TPC commands on the multi-panel uplink transmissions for both an uplink control channel and an uplink data channel in at least two panels; and
determining the TPC setting for each panel uplink transmission based on the received RRC signaling settings.

20. The method of claim 14, further comprising:
the group common DCI including multiple DCIs respectively located in first and second portions of a downlink transmission each of which is associated with respective first and second sets of physical resources in the downlink transmission, wherein the first portion of the downlink transmission associated with the first set of physical resources indicates a first portion of the TPC information for a first panel and the second portion of the downlink transmission associated with the second set of physical resources indicates a second portion of the TPC information for a second panel; and
determining the TPC setting for each panel uplink transmission based on the indications of the first and second portions of the TPC information.

21. The method of claim 20, wherein the first and second portions of the downlink transmission are corresponding common search space sets and the first and second sets of physical resources are corresponding different types of CORESETs in a serving cell.

22. The method of claim 21, wherein each CORESET of the different types of CORESETs is configured with a corresponding index number, where each index number is correlated to a corresponding panel identifier (ID) that identifies a panel of the multi-panel uplink transmissions such that the index number indicates the corresponding panel ID, and further comprising:
determining the TPC setting for each panel uplink further based on the corresponding panel ID.

23. The method of claim 21, further comprising:
receiving a panel identifier (ID) for each panel transmission of the multi-panel uplink transmissions, wherein each panel ID is based on a sounding reference signal (SRS) Resource ID for an SRS resource set for a codebook based multiple input and multiple output (MIMO) scheme in a respective one of the first or second sets of physical resources in the downlink transmission.

24. The method of claim 23, further comprising:
receiving a panel identifier (ID) for each panel transmission of the multi-panel uplink transmissions, wherein each panel ID is based on a sounding reference signal (SRS) resource set ID for an SRS resource set for a non-codebook based MIMO scheme in a respective one of the first or second sets of physical resources in the downlink transmission.

25. A wireless communication device, comprising:
a processor;
a wireless transceiver communicatively coupled to the processor; and
a memory communicatively coupled to the processor, wherein the processor and the memory are configured to:
receive, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions; and
determine the TPC setting for each panel uplink transmission based on the received group common DCI.

26. A wireless communication device in a wireless communication network, comprising:
means for receiving, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions; and
means for determining the TPC setting for each panel uplink transmission based on the received group common DCI.

27. An article of manufacture for use by a wireless communication device in a wireless communication network, the article comprising:
a computer-readable medium having stored therein instructions executable by one or more processors of the wireless communication device to:
receive, at a scheduled entity, group common downlink control information (DCI) that includes transport power control (TPC) information for multi-panel uplink transmissions by the scheduled entity, wherein the TPC information is configured to provide an indication for TPC pertaining to each panel uplink transmission in the multi-panel uplink transmissions; and
determine the TPC setting for each panel uplink transmission based on the received group common DCI.
